(19) United States
(12) Patent Application Publication
(10) Pub. No.: US 2004/0043349 A1
(43) Pub. Date: Mar. 4, 2004

(54) Illuminated mouthpiece

(76) Inventor: Chu-Yuan Liao, Taipei (TW)

Correspondence Address: LaMORTE & ASSOCIATES, P.C., P.O. BOX 434, Yardley, PA, 19067-8434, US

(21) Appl. No.: 10/228,400

(22) Filed: Aug. 27, 2002

(51) Int. Cl. A61C 3/00; F21K 2/00

(52) U.S. Cl. 433/29; 362/34

(57) ABSTRACT

An illuminated device, such as a mouth guard, pacifier or a set of false teeth, that is either held within or by a user's mouth. The device includes at least one light source, a battery for providing power to the light source and an on/off switch for selectively activating the light source. The device may also include a lighting sequence controller for selectively flashing the light source or lighting different light sources in a predetermined sequence. The on/off switch may be positioned within the mouth. Accordingly, the lighting of the light sources can be selectively controlled by the movement of some part of the mouth, such as the lips, teeth or tongue.

### BACKGROUND OF THE INVENTION

1. Field of the Invention

The present invention relates to electrically illuminated devices that are supported in or by a person's mouth.

2. PRIOR ART STATEMENT

The prior art record is replete with different types of objects that are designed to be supported in or by a person's mouth. For example, many musical instruments, such as bagpipes, have mouthpieces that are supported in the mouth. Infants often suck on pacifiers that are held in the infant's mouth. Football players wear mouth guards in their mouths that help protect their teeth from injury.

In the field of illumination, there are also many items that are supported in or by a person's mouth. Some illuminated items have functional uses, many others simply add illumination to an object for the purposes of aesthetics or novelty. For example, in U.S. Pat. No. 5,063,483 to Feilmeier, entitled Battery Powered Light With Mouthpiece, a flashlight is shown having a base that can be held in the mouth. In this manner, a person can comfortably hold a flashlight in their mouths to illuminate an object while still having both their hands free.

U.S. Pat. No. 6,299,441 to Novak, entitled Chemiluminescent Mouthpiece discloses a mouthpiece that is illuminated with chemical light. The light generated by the light stick exists solely for aesthetics and adds novelty to the appearance of the mouthpiece.

U.S. Pat. No. 5,007,924 to Jekel, entitled Luminescent Pacifier, discloses an infant's pacifier that is illuminated for both functional reasons and aesthetic reasons. The pacifier has a handle that is coated with a photo luminescent material. The photo luminescent material adds to the visual appeal of the pacifier and also makes the pacifier easier to locate in low light conditions.

In all of the illuminated prior art devices that are held in the mouth, the mouth does nothing but support the illuminated object. No parts of the mouth, i.e. lips, teeth or tongue, are used in any manner to control the illumination mechanism.

The present invention is a device that is held in the mouth and has internal illumination, however, the internal illumination can be selectively controlled by the lips, teeth or tongue. Consequently, a person can selectively illuminate the mouth-held device without having to remove the mouth-held device or otherwise engage the device with one's hands. The structure and method of operation for the present invention are described and claimed below.

### SUMMARY OF THE INVENTION

The present invention is an illuminated device, such as a mouth guard, pacifier or a set of false teeth, that is either held within or by a user's mouth. The device includes at least one light source, a battery for providing power to the light source and an on/off switch for selectively activating the light source. The device may also include a lighting sequence controller for selectively flashing the light source or lighting different light sources in a predetermined sequence. The on/off switch may be positioned within the mouth. Accordingly, the lighting of the light sources can be selectively controlled by the movement of some part of the mouth, such as the lips, teeth or tongue.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a schematic view illustrating the electronic components of the present invention device;

FIG. 2 is a perspective view of a person's face holding an embodiment of the present invention device in their mouth;

FIG. 3 is a perspective view of a mouthpiece device in accordance with the present invention;

FIG. 4 is a selectively cross-sectioned view of the exemplary embodiment of a mouthpiece shown in FIG. 3;

FIG. 5 is perspective view of a novelty set of false teeth in accordance with the present invention; and

FIG. 6 is a top view of a pacifier device in accordance with the present invention.

### DETAILED DESCRIPTION OF THE INVENTION

The present invention is an illuminated device that is held within or by the mouth. The present invention device can be embodied in several different forms. A plurality of exemplary embodiments of the present invention are presented below. The illustrated embodiments represent the best modes contemplated for the invention. However, it should be understood that illustrated embodiments are merely exemplary and other embodiments are intended to be included within the scope of the claims.

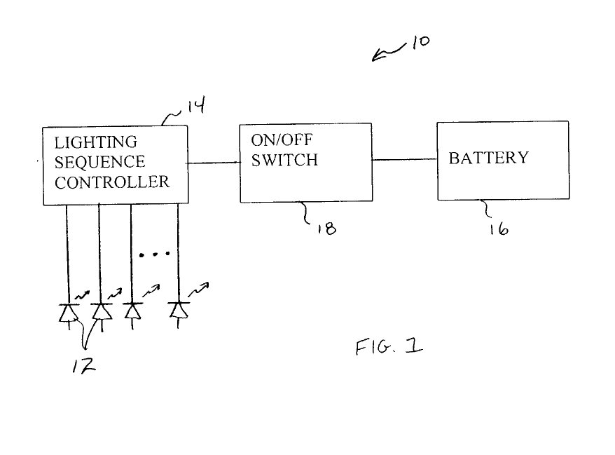

Referring to FIG. 1, a schematic of the electronic components of the present invention device 10 are shown. The components in the schematic of FIG. 1 are shared by all of the embodiments of the invention described in this specification. How the various components are configured and where these components are located that differentiates the embodiments.

As can be seen, the present invention device 10 contains at least one light emitting diode (LED) and preferably a plurality of LEDs 12. The LEDs 12 are controlled by a lighting sequence controller 14. The lighting sequence controller 14 flashes the LEDs 12 present either in unison or in a predetermined sequence. The LEDs 12 are powered by a battery 16. However, the power from the battery 16 to the LEDs 12 is selectively controlled by an on/off switch 18.

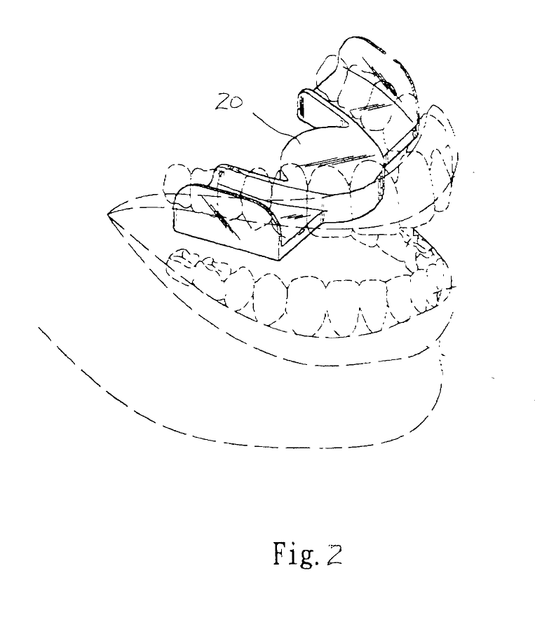

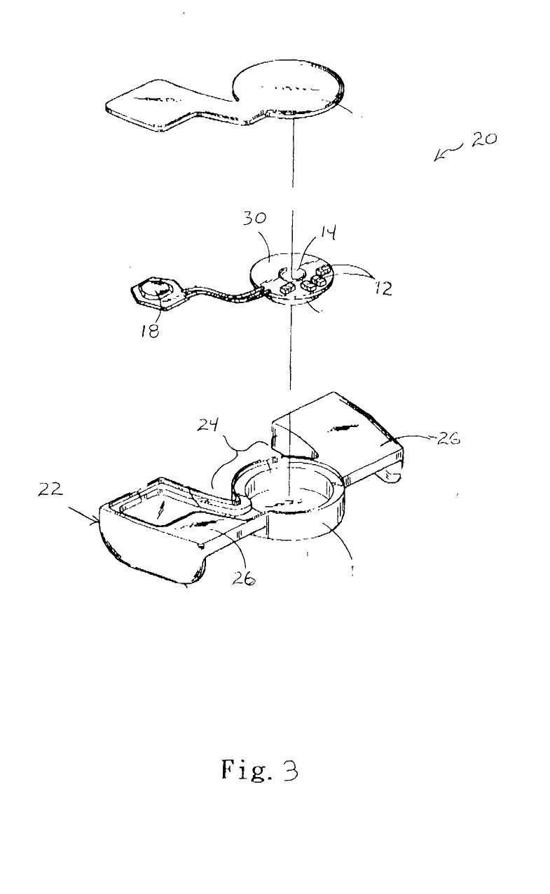

Referring to FIG. 2, the present invention is embodied as a mouthpiece 20 that is held within the mouth by the teeth. Mouthpieces that are held in the mouth in this manner are often used as standard equipment in contact sports, such as football, boxing, hockey and the like. What makes the present invention mouthpiece 20 different from other mouthpieces 20 is that within the mouthpiece are contained all the electronic components of the schematic of FIG. 1. As such, the mouthpiece contains LEDs, a lighting sequence controller, a battery and an on/off switch, the location of which will be later described with reference to FIG. 3.

The body of the mouthpiece 20 is molded from a translucent polymer. As such, the material of the mouthpiece 20 surrounding the LEDs is translucent. This enables light from the LEDs to be viewed through the body of the mouthpiece 20. Accordingly, when a person wearing the mouthpiece 20 smiles, or otherwise parts his/her lips, an illuminated mouthpiece 20 will be seen by anyone who may be observing.

Since the present invention mouthpiece 20 contains a light sequencing controller that controls the operation of the LEDs, each LED can be caused to periodically flash. If multiple LEDs are present, the LEDs can be sequentially flashed in predesigned patterns. Thus, the illuminated mouthpiece 20 can appear to flash or contain moving lights.

Referring now to FIG. 3, the general structure of a mouthpiece 20 is shown in accordance with the present invention. The mouthpiece 20 has a body 22 that is molded from a soft translucent or transparent material. There are many body shapes for mouthpieces. Most any existing mouthpiece shape can be adapted for use within the present invention.

In the illustrated mouthpiece body 22, there is a central section 24 and two bite plates 26 that extend from the central section 24. When the mouthpiece 20 is placed in the mouth, the bite plates 26 are engaged between the upper and lower teeth, thus holding the mouthpiece 20 firmly within the mouth. When in the mouth, the front of the central section 24 is the part of the mouthpiece 20 that protrudes furthermost in the mouth. Within the front part of the central section 24 are located the light emitting diodes (LEDs) 12. The LEDs 12 can emit any selected color of light. However, LEDs most commonly emit white, red, green or blue light, depending upon the type of LED 12 selected.

The activation of the LEDs 12 is controlled by the on/off switch 18. The on/off switch 18 is encapsulated within the structure of one of the bite plates 26 of the mouthpiece body 22. Accordingly, by selectively biting on the area of the bite plate 26 containing the on/off switch 18, the on/off switch 18 can be selectively controlled between its “on” condition and its “off” condition. Since the on/off switch 18 is controlled by the pressure applied by a person's teeth, once the mouthpiece 20 is placed in the mouth, it can be selectively turned on and off without having to be removed from the mouth. A person can therefore selectively turn the LEDs 12 in the mouthpiece 20 on and off without having to touch the mouthpiece 20 with his/her hands.

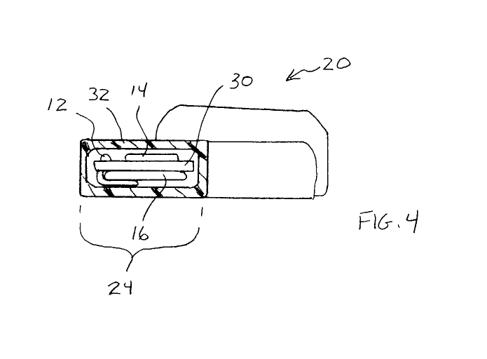

Although a single light source can be used in the mouthpiece 20, preferably more than one light source is used. If more than one light source is used, the light sources can be selectively illuminated in a predetermined sequence. In the shown embodiment, there are four LEDs 12. Once activated, the LEDs 12 can be selectively flashed, either in unison or in sequence. Referring to FIG. 4 in conjunction with FIG. 4, it can be seen that the LEDs 12 are attached to a small circuit board 30. Circuitry for a lighting sequence controller 14 is also contained on the circuit board 30. It is the lighting sequence controller 14 that controls the lighting of the various LEDs 12, once the device is activated. As previously stated, the lighting sequence controller 14 can be a simple flashing circuit or a sequential flashing circuit, thereby lighting the LEDs 12 either in unison or in a predetermined sequence, respectively.

Referring now solely to FIG. 4, it can be seen that the battery 16 that powers the LEDs 12 is positioned directly below the circuit board 30 The entire electronic assembly of the LEDs 12, circuit board 30 and battery 16 is encapsulated within a chamber 32 in the central section of the mouthpiece 20. The interior of the chamber 32 is environmentally isolated. Consequently, no moisture from a person's mouth can enter the chamber 32 and effect the operation of the electronic components. Furthermore, by sealing the electronic components within the chamber 32, the electronic components cannot be removed from the chamber 32 and become either a poisoning hazard or a choking hazard.

Since the battery 16 that powers the LEDs 12 is sealed within the chamber 32 in the central section 24 of the mouthpiece 20, the battery 16 cannot be replaced. However, standard commercial batteries can power the LEDs 12 for many hours. Therefore, the ability to selectively activate the LEDs 12 with the mouth-operated on/off switch becomes important in prolonging the battery life, and thus the functional life, of the device.

In the embodiment of the mouthpiece 20 just described, the entire body 22 of the mouthpiece 20 is contained within the mouth. Thus, the mouthpiece 20 is only visible to another person when the person wearing the mouthpiece 20 smiles or otherwise parts his/her lips.

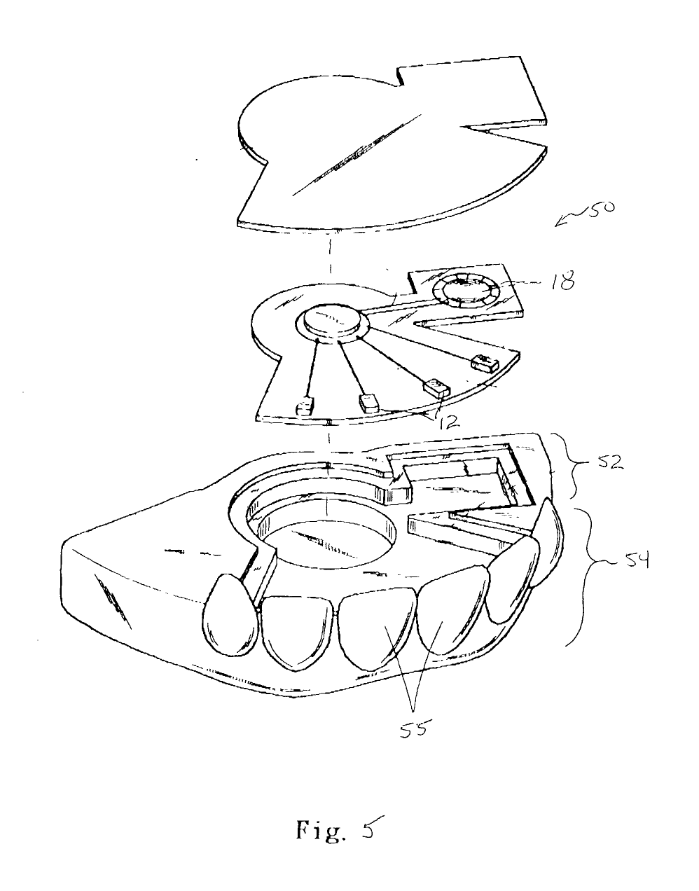

Referring now to FIG. 5, an alternate embodiment of the present invention device 50 is shown, where the device 50 has a mouthpiece section 52 that passes into the mouth behind the teeth of the user an external section 54 is supported in front of the teeth of the user. In the shown embodiment, the external section 54 is a false set of teeth. Thus, the device 50 is purely a novelty device rather than a functional sports mouthpiece.

The LEDs 12 of the device 50 are used to illuminate the external section 54 of the novelty device 50. In the shown embodiment, the external section 54 is formed with fake teeth 55. The teeth 55 can be made of translucent material. The LEDs 12 can be positioned behind the fake teeth 55 in the external section 54. As such, when the LEDs 12 light, the tooth in front of that LED 12 becomes illuminated. Accordingly, if the LEDs 12 are lit in a sequence, the teeth 55 on the external section 54 will flash in that same sequence, thereby producing a very novel appearance.

An on/off switch that controls the activation of the LEDs 12 can be located on the external section 54 of the device 50. If the on/off switch were placed on the external section 54, a person can selectively activate and deactivate the device 50 by pressing the on/off switch with their fingers. However, the novelty of the device 50 is improved by placing the on/off switch 18 in the mouthpiece section 52 of the device 50 so that the LEDs 12 can be selectively activated using pressure from the teeth, or another part of the mouth such as the lips or tongue. In the shown embodiment, the on/off switch 18 is located in one of the side flanges of the device. As such, the on/off switch 18 can be activated with a person's teeth. By using a novelty device 50 configured in such a manner, a person can first surprise another person by the presence of the device 50 in his/her mouth. That other person can then be surprised a second time by illuminating the device 50 with a minor movement of the teeth, lips or tongue.

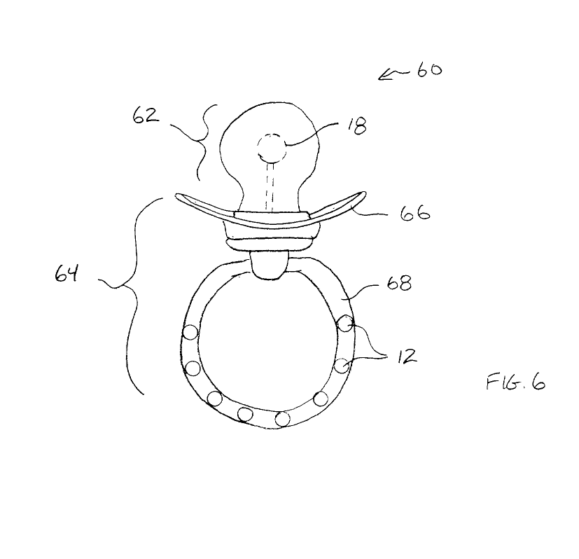

Referring to FIG. 6, the present invention device is shown embodied as a pacifier 60. The pacifier 60 has a nipple section 62 that is received within the mouth. An external section 64 extends from the nipple section 62 that does not enter into the mouth. In the shown embodiment, the external section 64 is comprised of a safety plate 66 and a ring handle 68. In applying the technology of the present invention to the structure of the pacifier 60, LEDs 12 are placed in the ring handle 68. The battery and control circuitry are contained within the safety plate 66. Lastly, the on/off switch 18 is positioned within the structure of the nipple section 62. As such, when a child sucks on the nipple section 62 or otherwise squeezes the nipple section 62, the on/off switch 18 will be engaged and the LEDs 12 will light. Again the LEDs 12 can flash in unison or in some predetermined sequence.

Since the pacifier 60 contains an external section 64 that does not enter the mouth, the battery and circuit board of the pacifier 60 can be located in the external section 64. The battery can therefore be made removable since it is not at risk of getting wet or of becoming a choking hazard

It will be understood that the system and method of the present invention described and illustrated are merely exemplary and a person skilled in the art can make many variations to the shown embodiment. For example, there are many types of mouthpieces, false teeth sets and pacifiers that exist. Any known design can be adapted for use as part of the present invention system. The arrangement of LEDs in the various embodiments can also be arranged in different patterns other than has been shown. All such alternate embodiments and modifications are intended to be included within the scope of the present invention as defined below in the claims.

What is claimed is:

1. An illuminated mouthpiece device comprising:
a mouthpiece having a central section and at least one bite plate that extends from said central section;
at least one light source contained within said mouthpiece;
an on/off switch for selectively activating said at least one light source disposed within said bite plate.

2. The device according to claim 1, wherein said at least one light source includes a plurality of light emitting diodes.

3. The device according to claim 1, further including a controller contained within said mouthpiece for selectively flashing said at least one light source.

4. The device according to claim 2, further including a sequence controller contained within said mouthpiece for lighting each of said light emitting diodes in a predetermined sequence.

5. The device according to claim 4, further including a battery contained within said mouthpiece for powering said plurality of light emitting diodes.

6. The device according to claim 5, wherein said light emitting diodes, said sequence controller and said battery are sealed within said mouthpiece so as to be isolated from any adverse environment surrounding said mouthpiece.

7. The device according to claim 5, wherein said mouthpiece is molded from a translucent material.

8. An illuminated novelty device that is held in a user's mouth, comprising:
a mouthpiece section that passes into a user's mouth;
an external section coupled to said mouthpiece section that is suspended external of the user's mouth when said mouthpiece section is placed in the user's mouth;
at least one light source contained within said external section that produces light that is visible on said external section;
a switch for selectively activating said at least one light source.

9. The device according to claim 8, wherein said switch is disposed in said mouthpiece section.

10. The device according to claim 8, wherein said at least one light source includes a plurality of light emitting diodes.

11. The device according to claim 8, further including a controller for selectively flashing said at least one light source.

12. The device according to claim 12, further including a sequence controller for lighting each of said light emitting diodes in a predetermined sequence.

13. The device according to claim 12, further including a battery for powering said plurality of light emitting diodes.

14. The device according to claim 8, wherein said switch is located on said external section.

15. The device according to claim 8, wherein said novelty device is configured as a set of false teeth.

16. The device according to claim 8, wherein said novelty device is configured as a pacifier.

17. A method of illuminating a novelty device that is at least partially held in a user's mouth, comprising the steps of:
providing a circuit containing at least one light source, a battery and an on/off switch for selectively activating said at least one light source;
providing a device having a section that is held in a user's mouth, wherein said device supports said circuit;
positioning said on/off switch in said section that is held in a user's mouth, wherein said on/off switch can be selectively controlled by manipulation within the mouth.

18. The method according to claim 17, wherein said section of said device held in a user's mouth includes a bite plate that is held between the upper and lower teeth within the mouth and said on/off switch is disposed in said bite plate so as to be selectively activated by contact with the teeth.

19. The method according to claim 17, wherein said section of said device held in a user's mouth is formed as the nipple to a pacifier and said on/off switch is disposed within said nipple so as to be selectively activated when said nipple is sucked upon.
